(19) United States
(12) Patent Application Publication
(10) Pub. No.: US 2014/0306496 A1
(43) Pub. Date: Oct. 16, 2014

(54) Adjustable Bicycle Seat

(71) Applicant: John Woodward, Saugus, MA (US)

(72) Inventor: John Woodward, Saugus, MA (US)

(21) Appl. No.: 14/254,819

(22) Filed: Apr. 16, 2014

Related U.S. Application Data
(60) Provisional application No. 61/812,620, filed on Apr. 16, 2013.

(51) Int. Cl. B62J 1/10

(52) U.S. Cl. CPC B62J 1/10
USPC 297/204

(57) ABSTRACT

A multi-adjustable bicycle seat configured to conform to a cyclist having a flexible material suspended over the front and rear portions of a frame, wherein at least one adjusting mechanism causes the flexible material to adjust the tension throughout the seat, flatten or otherwise deform the seat to the desired comfort of a rider. The seat material may be completely removable from the frame portion.

### CROSS REFERENCE TO RELATED PATENT APPLICATIONS

This patent application claims the benefit of U.S. Patent Application 61/812,620 filed on Apr. 16, 2013, which is incorporated herein by reference.

### COPYRIGHT STATEMENT

A portion of the disclosure of this patent application document contains material that is subject to copyright protection including the drawings. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of the Invention

This invention relates to seats for bicycles and more particularly to a seat that is adjustable.

2. Description of the Prior Art

Bicycling has many benefits, but if the bicycle seat is too narrow or too wide it may interfere with enjoyment of cycling comfortably. Furthermore, previous bicycle seats generally are limited in their ability to adjust or conform to the body of an individual rider. Thus, a seat having the ability to conform to an individual rider and varied depending on the type of rider or ride is desired. The present application seeks to address this and other limitations of current bicycle seats.

### SUMMARY OF THE INVENTION

In an embodiment of a bicycle seat, the bicycle seat includes a seat frame having a rail extending from a nose portion to a rear crossbar. The bicycle seat has a seat portion of a flexible material that is formed over a portion of the nose and the crossbar. The bicycle seat has an adjustable mounting mechanism interposed between the flexible material and the rear crossbar of the frame. The adjustable mounting mechanism is capable of causing adjustment of at least a portion of the flexible material to transform along at least one direction and adjustment of the seating properties of the seat portion.

In an embodiment, the adjustable mounting mechanism of the bicycle seat is a hook and loop fastener. In an embodiment, the adjustable mounting mechanism of the bicycle seat is a ratchet mechanism.

In an embodiment, the bicycle seat includes a seat attachment and tilting mechanism that is secured to the rail. In an embodiment, the seat portion of the bicycle seat has a nose segment and a seat segment.

In an embodiment, the flexible material of the seat portion is a woven material. In an embodiment, the flexible material of the seat portion is a rubber.

In an embodiment, the seat portion has a coating on the nose segment of the flexible material. In an embodiment, the coating is Teflon.

In an embodiment, the bicycle seat includes a high-friction material or coating on the seat portion.

In an embodiment, the material of the seat portion includes a plurality of openings for venting.

In an embodiment, the transformation of the material causes the material to change the position of the seat portion.

In an embodiment, the ratio of the length of the seat portion to the width of the seat portion is greater than 1:1.2. In an embodiment, the ratio of the length of the seat portion to the width of the seat portion is greater than 1:1.5. In an embodiment, the ratio of the length of the seat portion to the height of the seat portion over the rails is a ratio of less than 7:1.

In one embodiment, a multi-adjustable seat is comprised of a frame having a first tensioning mechanism, a textile material formed over a portion of the frame and attached to the first tensioning mechanism. The tensioning mechanism is configured to adjust the stiffness and curvature of the textile for at least one portion and along at least one direction of the textile material.

Additional adjusting mechanisms may be incorporated to adjust the radii of curvature of the seat from the nose portion to the back for the respective thigh and pedaling stroke of the thighs of users. For example, one adjustment mechanism may cause the nose portion to become narrower, e.g. a cinching device like a zip tie may be used. A cinching mechanism such as Velcro® may also be built directly into the textile material on two portions of the textile material allowing them to be tightened or formed around the nose portion. Two strings cinching the textile material and other such mechanisms like a strap that is formed directly into the textile material have also been considered.

Another adjustment mechanism may be configured directly into the textile material itself such as a zipper, which allows the length of the nose portion to extend further into the rear portion of the seat. This adjustment allows for individuals to make longer or further back pedal strokes without the back of the leg hitting the seat while pedaling. For example, in one configuration the textile material is unzipped 4 cm on each side for a comfortable ride, while unzipping each side 6 cm allows a longer, less wide, more narrow nose portion helping the rider to make longer back pedal strokes without hitting their leg into the seat.

In some embodiments the first tensioning mechanism may be comprised of a crank, reel, hook and loop (Velcro®) system, or other tensioning mechanism known in the art.

In some embodiments the textile material is inelastic, flexible, porous, and water resistant.

In some embodiments, an aerated front nose piece is formed as part of the frame in order to promote increased airflow, wherein the textile material is formed around and attached to the nose piece. The nose piece may have holes, an abscess, or otherwise promote airflow through to the sitting area to reduce chafing and dampness due to perspiration.

In some embodiments a tilting mechanism is formed as part of the seat to adjust the overall angle of the seat with respect to the bicycle. This tilting mechanism may also be attached to a post used to slidably insert into a bicycle frame.

In an embodiment of a bicycle seat, the seat includes a seat frame having a rail that extends from a nose portion to a rear crossbar. The seat has a seat portion of a flexible material that is formed over a portion of the nose and the crossbar. The seat portion has a nose segment and a seat segment. The bicycle seat has a hook and loop fastener interposed between the flexible material and the rear crossbar of the frame. The adjustable hook and loop fastener mounting mechanism is capable of causing at least a portion of the flexible material to transform along at least one direction. The transformation of the material causes the material to change the position of the seat portion.

In an embodiment, the adjustable bicycle seat has a coating on the nose segment of the flexible material.

In an embodiment, the seat portion has a high-friction material or coating.

In an embodiment, the seat portion has a plurality of openings in the material for venting. In an embodiment, the ratio of the length of the seat portion to the width of the seat portion is greater than 1:1.5.

In an embodiment, the seat attachment and tilting mechanism is secured to the rail.

These and other embodiments are described in more detail herein.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a perspective view of an adjustable bicycle seat according to the invention; exploded away from a bicycle post;

FIG. 2A is a exploded perspective view of the adjustable bicycle seat;

FIG. 2B is a bottom view of the seat portion;

FIG. 3 is a side view of the adjustable bicycle seat;

FIG. 4 is a perspective view of an alternative frame for an adjustable bicycle seat;

FIG. 5 is a perspective view of an alternative frame for an adjustable bicycle seat;

FIGS. 6A and 6B illustrate a venting system incorporated into an adjustable bicycle seat;

FIG. 7 illustrates various adjustment mechanisms for use with an adjustable bicycle seat and the ways each seat may be adjusted or deformed;

FIGS. 8A-8C illustrate various side profiles of bicycle seats and the curvature that may be formed from nose to back;

FIG. 9 illustrates an adjustable seat having adjustability in the nose segment and web portion;

FIG. 10 illustrates various contours or wing portions that may be formed with the adjustable seats;

FIGS. 11A and 11B illustrate a top view of adjustments to the length and curvature of the nose portion of a bicycle seat;

FIG. 12 illustrates the frame portion of an adjustable bicycle seat;

FIG. 13 illustrates a rear rotatable crossbar for use with an adjustable bicycle seat; and

FIGS. 14A and 14B illustrate the cross-bar and frame of FIGS. 9 and 10 in two different configurations; and

FIGS. 15A and 15B illustrate a rotating mechanism for adjusting the crossbar with respect to the attached frame of an adjustable bicycle seat frame and a tool to make such adjustment.

### DETAILED DESCRIPTION OF THE INVENTION

The present application seeks to provide a solution to the aforementioned problems by a multi-adjustable bicycle seat that may conform to the use and comfort of an individual rider.

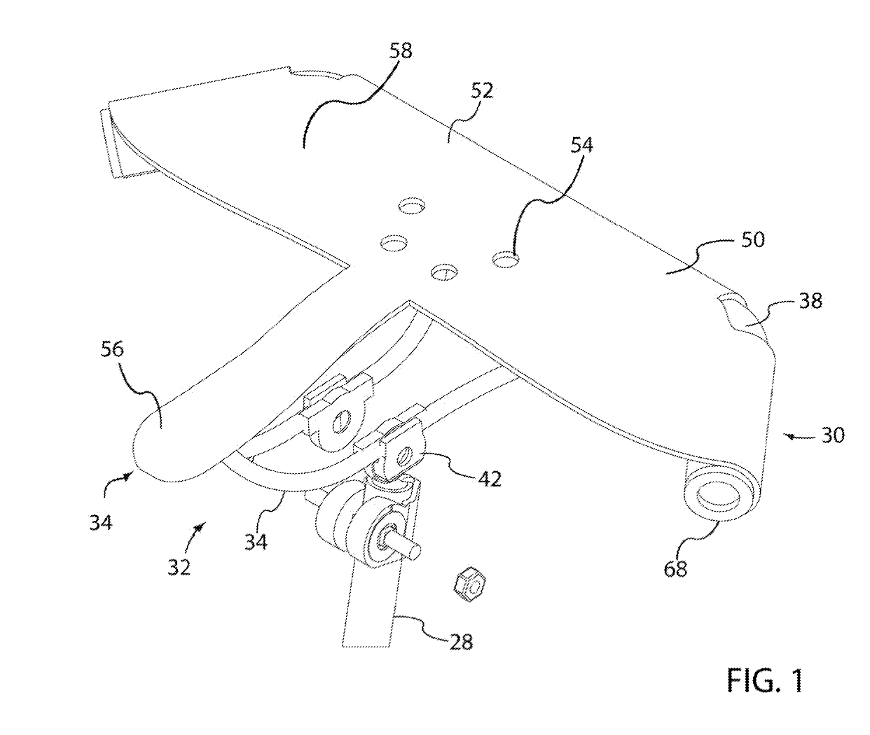

Referring to FIG. 1, a perspective view of an adjustable bicycle seat 30 according to the invention is shown. The adjustable bicycle seat 30 is shown exploded away from a bicycle post 28. The adjustable seat 30 has a seat frame or chassis 32 with a pair of rails 34 that extend from a nose 36 to a rear crossbar 38. The adjustable bicycle seat 30 has a seat attachment and tilting mechanism 42 that interacts and attaches to the bicycle post 28. The seat attachment and tilting mechanism, the seat post clamp 42, allows the seat frame or chassis 32, via the seat rails 34, to be attached to the bicycle post 28 or other feature of a bicycle frame. In addition the seat attachment and tilting mechanism 42 allows the seat frame 32 to be tilted such that the nose portion 36 is lower than the rear crossbar 38 and vice versa.

The adjustable bicycle seat 30 has a seat portion 50 that extends from the nose 36 to the rear crossbar 38. The seat portion 50 is formed of flexible material 52. In the embodiment shown the seat portion 50 has a plurality of ventilation holes 54.

The seat portion 50 while formed of one piece of flexible material 52 has several segments including a nose segment 56 which is narrow and a seat segment 58. In the embodiment shown the length from the nose 36 to the rear crossbar 38 is 10.6 inches (27 centimeters). The width of the nose segment 56 is 1.24 inches (3.14 centimeters). The width of the seat segment 58 is 16.5 inches (42 centimeters). The width of the seat segment 58 to the length of the seat is a ratio of greater than 1:1 and in the embodiment shown it is 42:27 or 1.55:1.

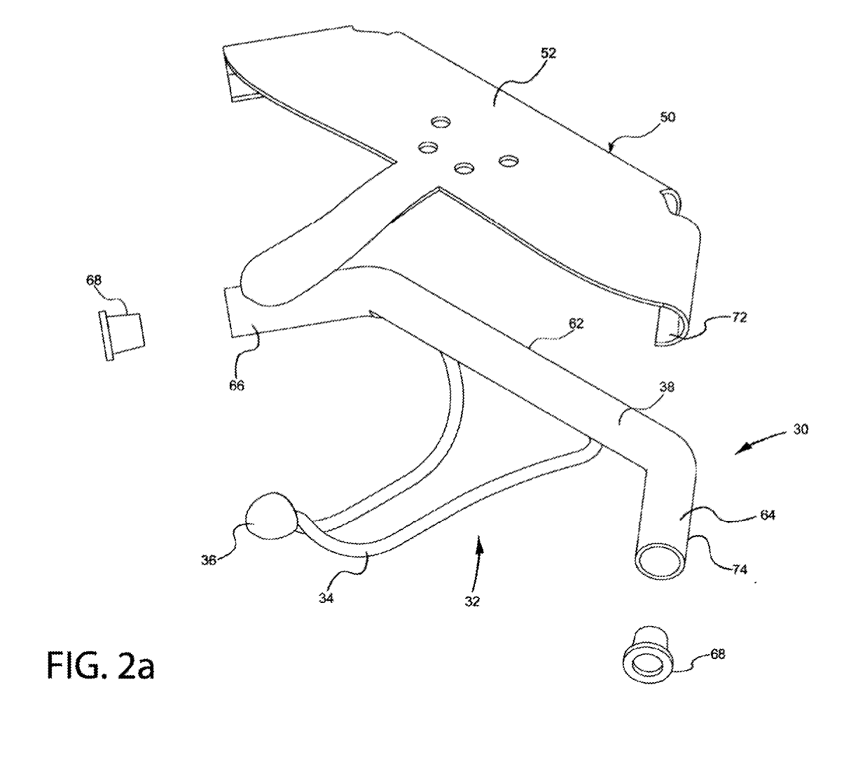

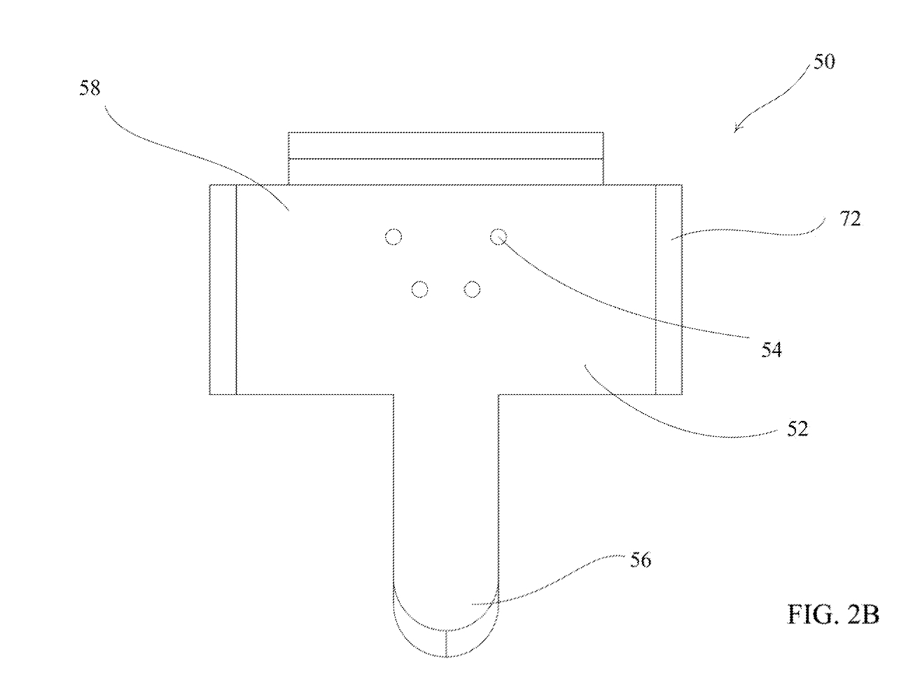

Referring to FIG. 2, an exploded perspective view of the adjustable bicycle seat 30 is shown. The seat attachment and tilting mechanism 42 for attaching to the bicycle post is not shown in FIG. 2. The seat frame 32 has the rails 34 that extend from the nose 36 to the rear crossbar 38. In the embodiment show, the rear crossbar 38 is one piece having a central back portion 62 and a left arm or wing 64 and a right arm or wing 66. The adjustable bicycle seat 30 has a pair of end caps 68 that are received in the end of the arms 64 and 66 of the rear crossbar 38.

Referring to FIG. 2B, a bottom view of the seat portion 50 is shown. The seat portion 50 has a plurality of hook fasteners 72 that are secured to the flexible material 52. The hook fasteners 72 interact with the loop fasteners 74 on the rear cross bar 38 to both secure and allow adjustment of the seat portion 50.

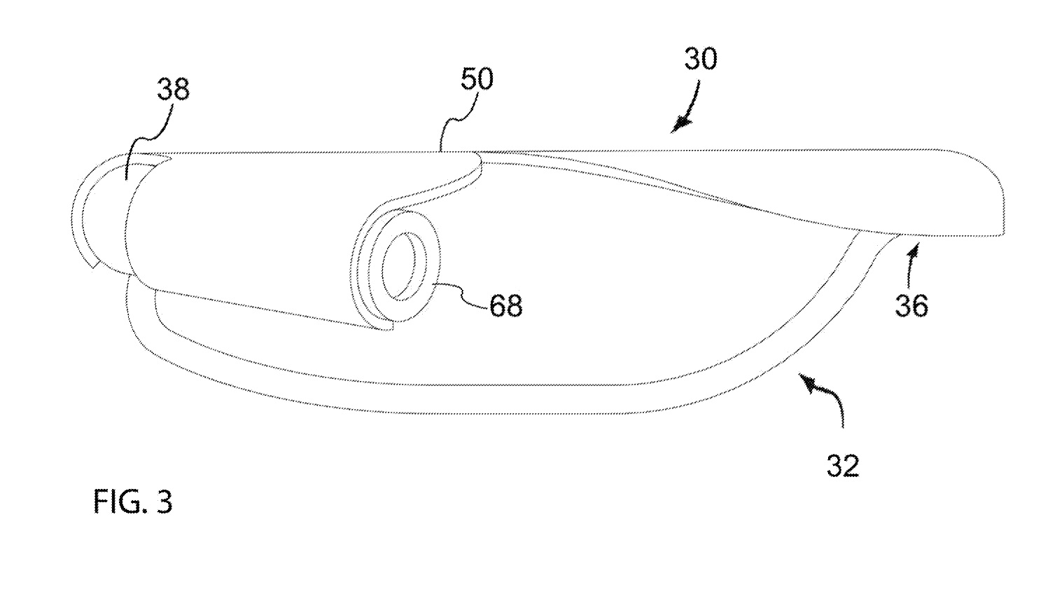

Referring to FIG. 3, a side view of the adjustable bicycle seat 30 is shown. The rail 34 of the seat frame 32 extends from the nose 36 to the rear crossbar 38. The seat portion 50 is spaced from the rails 34 in the center portion. In an embodiment, the seat portion 50 is over 2.36 inches (6 centimeters) from the rails 34. The ratio of the length of the seat to the height of the seat portion over the rails is a ratio of less than 7:1 and in the embodiment shown it is 4.49:1. The spacing of the rail from the seat portion allows the seat portion as the material gives or conform under the user's weight not to deform down to the rails 34.

The adjustment of the hook and loop fasteners 72 and 74, such as Velcro®, between the flexible material 52 of the seat portion 50 and the center back portion 62 of the rear cross bar 38 allows for adjustment of the curvature of the seat portion 50. The adjustment of the hook and loop fasteners 72 and 74 between the flexible material 52 of the seat portion 50 and the two arms 64 and 66 allows for adjustment of the flatness lengthwise, the flatness widthwise, the stiffness overall. It is recognized that the entire seat portion 50 can be replaced with other seat portion 50 with different material property.

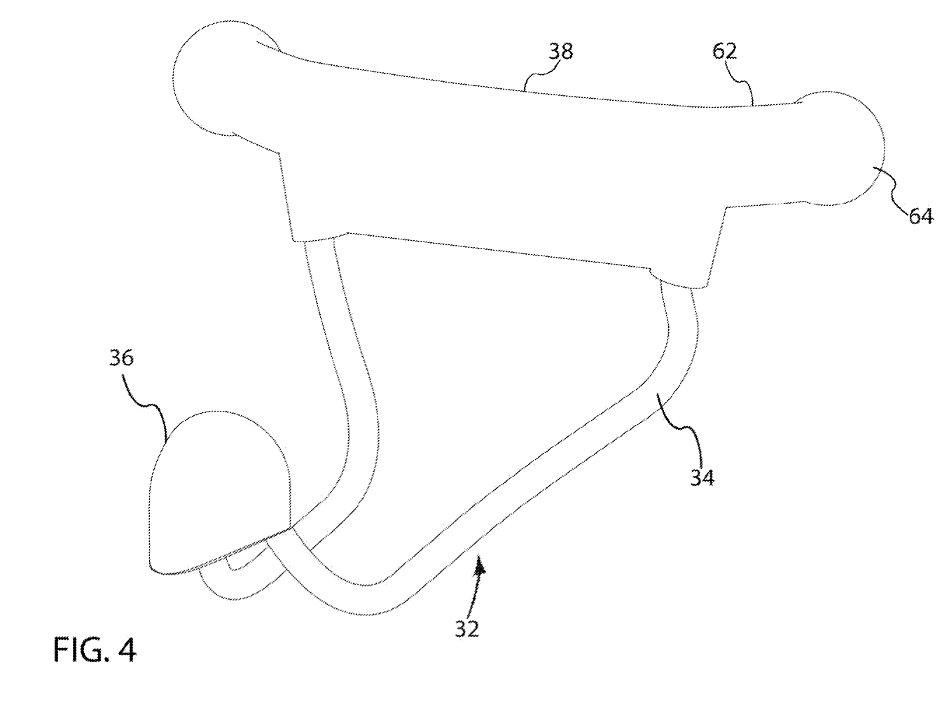

Referring to FIG. 4, a perspective view of an alternative frame for an adjustable bicycle seat 80 is shown. The seat frame or seat chassis 32 of the adjustable bicycle seat 80 includes a pair of rails 34 sweeping under a nose portion 36 and ending under a crossbar 38. The crossbar 38 has a center back portion 62 and a pair of arms or wings 64 and 66 extending rearward from the center rear portion 56.

The flexible material 52, not shown in this FIG., may be formed over a part of the nose portion 36 of the frame and extended to and formed over the center back portion 62 of the rear crossbar 38 and the arms 64 and 66. The arms 64 and 66 are generally used to help form the width and form of the seat portion 50.

In contrast to the embodiment shown in FIGS. 1-3 where the arms 64 and 66 project forward, the arms project backward in FIG. 4. The distinction between forward and backward projecting arms results is the forward projection influences the shape of the seating surface to be saddle-like and the backward facing projection eliminates the direct contact of the arms with the thighs of any user.

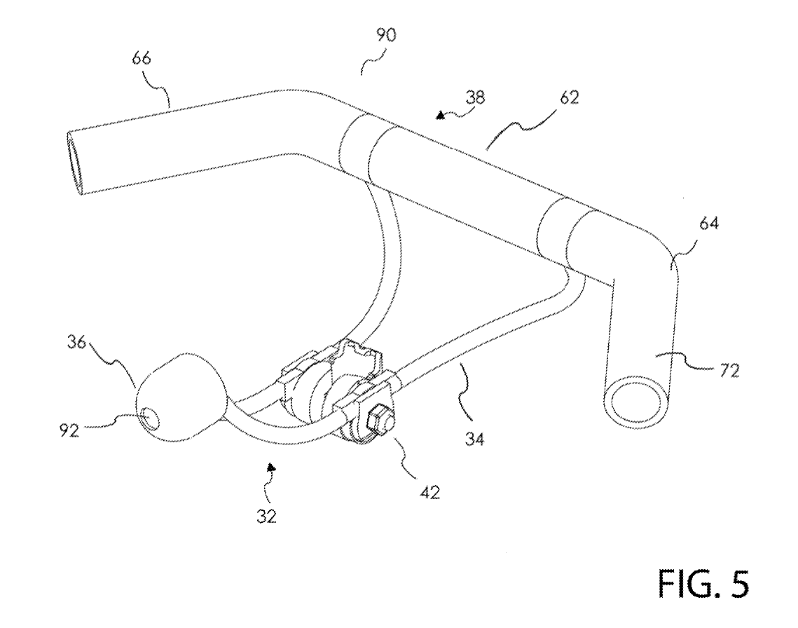

Referring to FIG. 5, a perspective view of an alternative frame 32 for an adjustable bicycle seat 90 is shown. The nose portion 36 of the seat frame 32 contains a through hole or aperture 90 that allows air to circulate through the nose portion 36 and under the flexible material 52 that is formed over the seat frame 32. In the seat frame 32, the arms 64 and 66 extend slightly forward (toward the nose portion 36) and outward. The arms 64 and 66 and the center back portion 62 of the rear cross bar 38 have hook fasteners 66 that work in conjunction with loop fasteners 68 on the flexible material 52 to secure the flexible material 52 over the seat frame 32 and form an adjustable seat 50.

Still referring to FIG. 5, the adjustable bicycle seat 90 shows the seat attachment and tilting mechanism 42. This seat attachment and tilting mechanism or seat post clamp 42 allows the seat frame 32, via the rails 34, to be attached to the bicycle post 28 or other feature of a bicycle frame. In addition the seat post clamp 42 allows the frame to be tilted such that the nose portion is lower than the crossbar and vice versa.

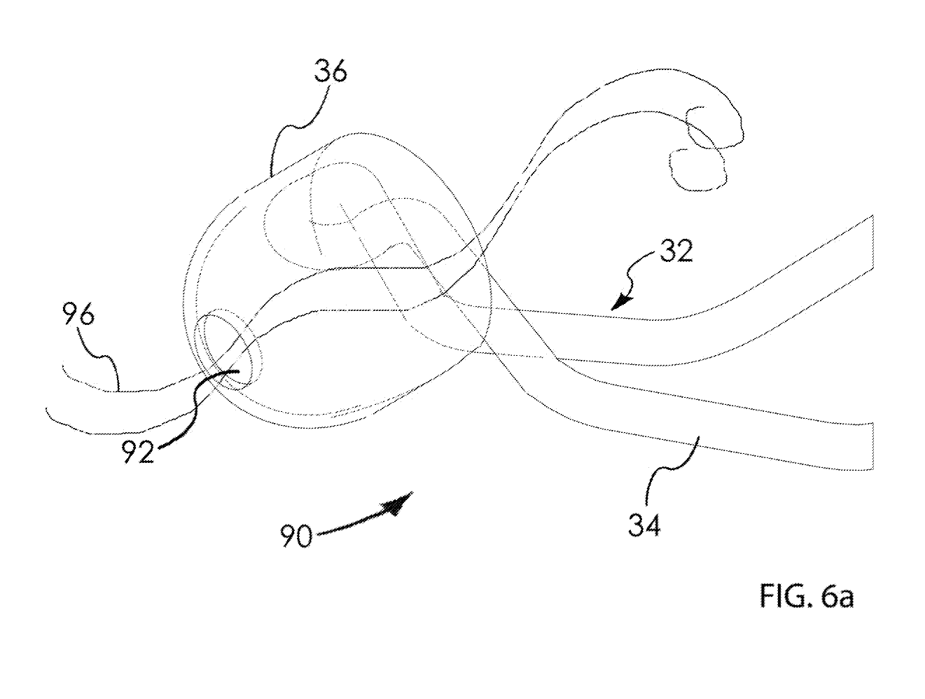

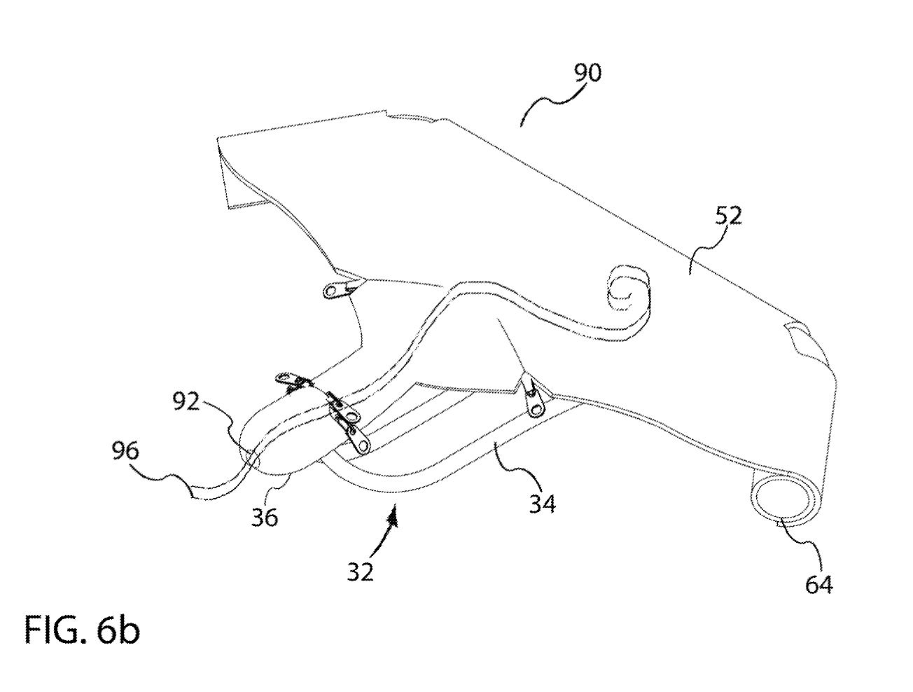

Referring to FIG. 6A, a closer view of a nose portion 36 having the through hole or aperture 92, through which air flow as represented by arrows 96 may travel, is shown. FIG. 6B illustrates an adjustable seat 90 having a flexible material 52, which is a textile material in the embodiment formed over the nose portion 36 of the seat frame 32 as well as the rear crossbar 38 including the center back portion 62 and the arms 64 and 66. The rails 34 of the seat frame 32 space the nose portion 36 and the rear crossbar 38 apart; the flexible material, the textile material, 52 is slung between the nose portion 36 and the rear crossbar 38. In the embodiment, the rails 34 are welded to the nose portion 36 and the rear crossbar 38.

The attachment and tilting mechanism 42, not shown in this FIG., is also fixed to the rails 34 of the seat frame 32. Air flow 96 is illustrated as entering through the opening 92 of the nose portion 36, flowing under the textile material 52, which may be porous, thus allowing the rider to be cooled. This may help prevent chaffing as it helps reduce and remove perspiration from a rider.

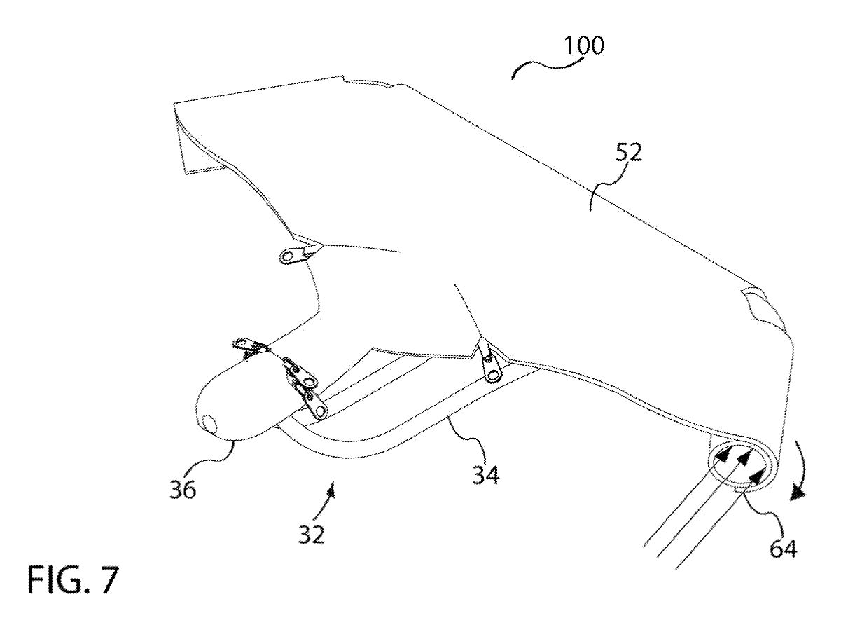

Referring to FIG. 7, various adjustment mechanisms for use with an adjustable bicycle seat 100 are illustrated and the ways each seat may be adjusted or deformed are shown. The adjustable bicycle seat 100 shown in FIG. 7 is similar to the adjustable bicycle seat 90 of FIG. 6B. However in contrast to the adjustable bicycle seat 90 of FIG. 6B, the adjustable bicycle seat 100 has a mechanical tightening mechanism 104 attached to or formed into the crossbar by which a “Front-to-Back” tightening of the seat may occur. The mechanical tightening mechanism 104 has a ratchet mechanism such as a window shade.

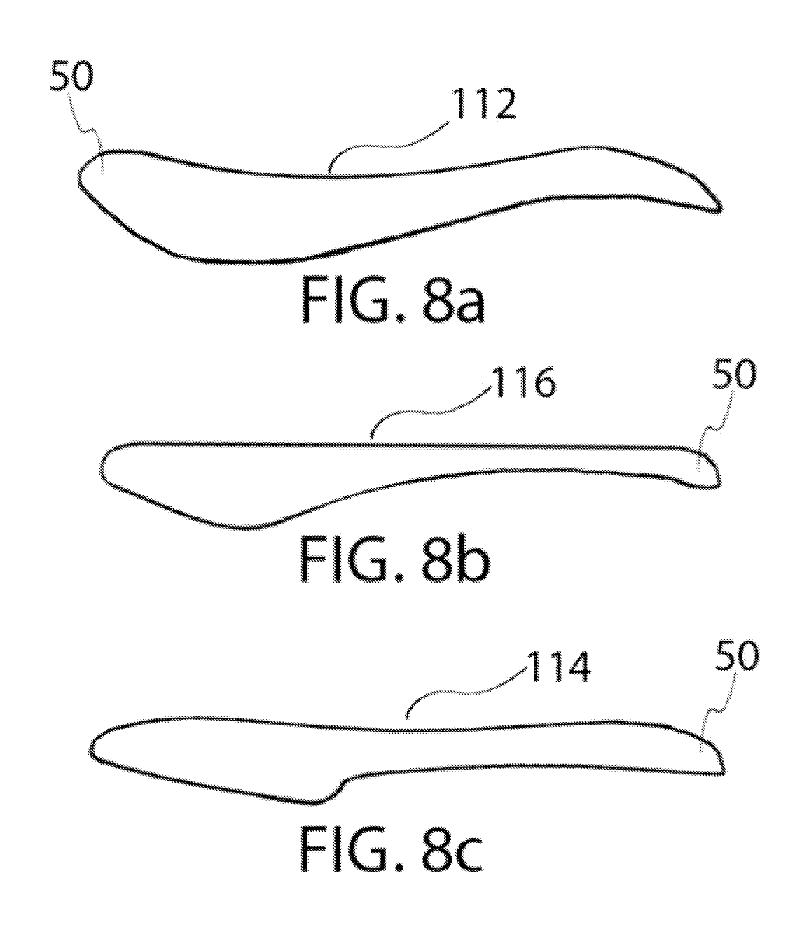

Referring to FIGS. 8A-8C, various side profiles of bicycle seats and the curvature that may be formed from nose to back are illustrated. The adjustment of the hook and loop fasteners 72 and 74 to adjust the flexible material 52 of the seat portion 50 with the center back portion 62 of the rear crossbar 38 adjusts the curvature. The dips and curves a “front-to-back” adjustment may allow for are illustrated in FIGS. 8A-8C. For example, the curve 102 formed in FIG. 8A has a deeper groove than the flat profile of 106 in FIG. 8C and the slight dip 104 shown in FIG. 8C.

Referring back to FIG. 7, the arms 64 and 66 may rotate up/down or in/out to help adjust the forming of the seat cover from “side-to-side.” The rotation of the arm varies the curvature or flatness of the seat. For example, the downward rotation of the arms 64 and 66 and the tightening of the center portion will increase the curvature. In some embodiments, not shown, arms 64 and 66 may extend inward, outward, up and down, which may be used as another method to adjust the “side-to-side” adjustment, width and form of the seat.

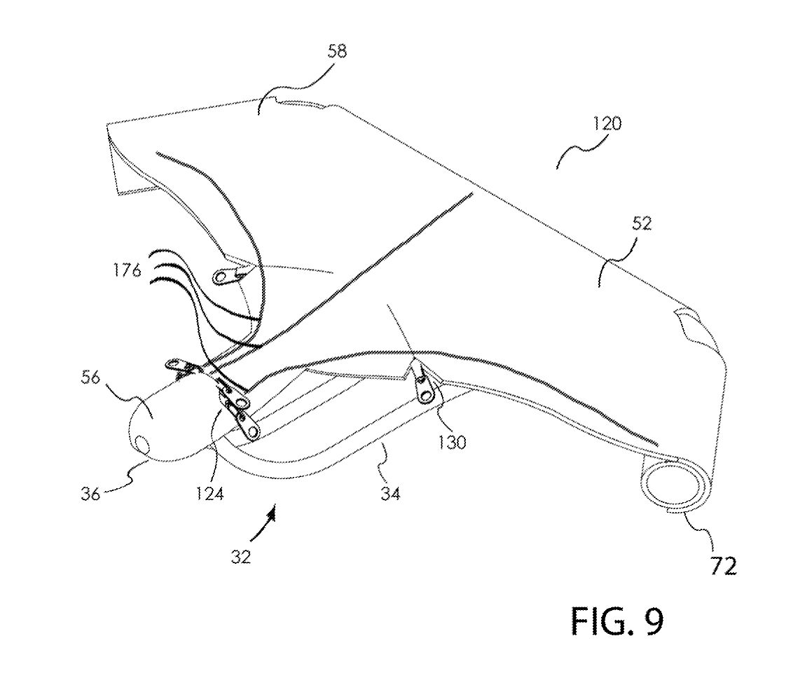

Referring to FIG. 9, the adjustable seat 120 having adjustability in the nose segment 56 and web or wing portion, the seat segment 58, of the seat portion 50 is shown. The flexible material 52 of the seat portion 50 has a stress distribution mechanism 124, such as zippers formed around the nose portion or segment 56 of the seat portion 50, which may be used to adjust the stress distribution lines formed in malleable or textile material 52 from the stress distribution mechanism 124 to the back portion of the seat portion 50. Stress distribution lines 126 have been drawn in for illustrative purposes to show that lines of tension or stress are formed along the seat that lead back to the nose portion. Depending how open or closed the stress distribution mechanism 124 is around the nose helps define where those stress lines are formed. This is important, because many riders have different body types that prefer pressure to be applied or reduced to the groin and buttocks area. One of the principles behind this stress distribution mechanism 124 is to determine the amount and area at which the stress lines are formed. Other stress distribution mechanisms 124 contemplated may include zip ties, straps, or strings built into the textile material 52, hook and loop material formed on a portion of textile material 52 and other mechanisms to adjust how much of the nose portion ‘sees’ the stress from the tightened seat. Though not all devices are described, any mechanism that adjusts these stress lines would be within the scope of this application.

In conjunction with the stress distribution mechanism 124, another sitting adjustment mechanism 130, such as a locking zipper formed in the flexible material 52, may be formed into the web portion or segment 60 of the seat which allows for the contour of the seat on each side to be adjusted.

The seat portion 50 is defined into three segments: the nose segment 56, the sitting segment 58, and an interposed wing segment 60. The sitting segment 58 includes a waterproof, ventilated, high-friction surface (e.g. coating or fabric add-on). The nose segment 56 includes a smooth, waterproof, low-friction (e.g. coating or fabric add-on).

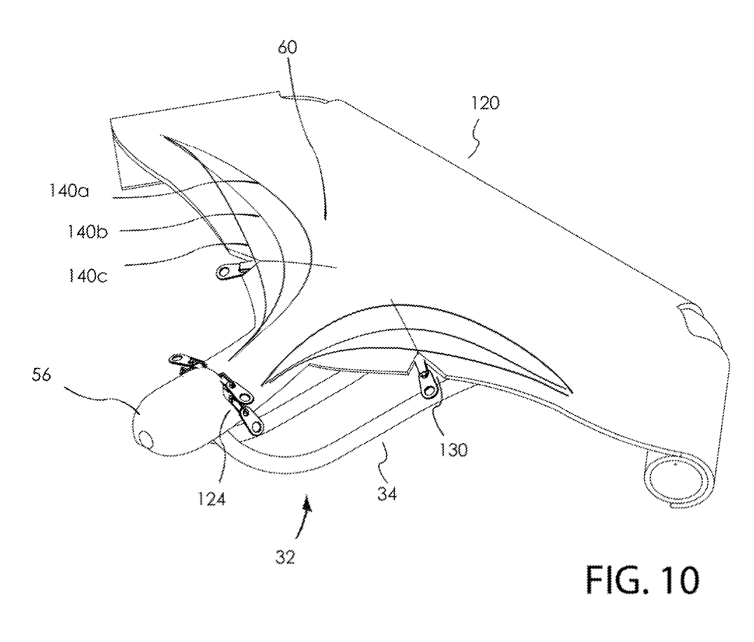

Referring to FIG. 10, various contours or wing segments 60 that may be formed with the adjustable seats are described herein. A contour line 140a shows a nose portion or segment 56 with minimal web/wing flare, the web segment 60, before the rear portion, the seat segment 58, of the seat portion 50; this change in the radius of curvature allows for further tailoring to the use and the type of ride. The contour line 140b illustrates a more gradual seat flaring from the nose portion to the rear portion, while the contour line 140c illustrates the widest variation with the shortest nose portion before flaring into the rear portion.

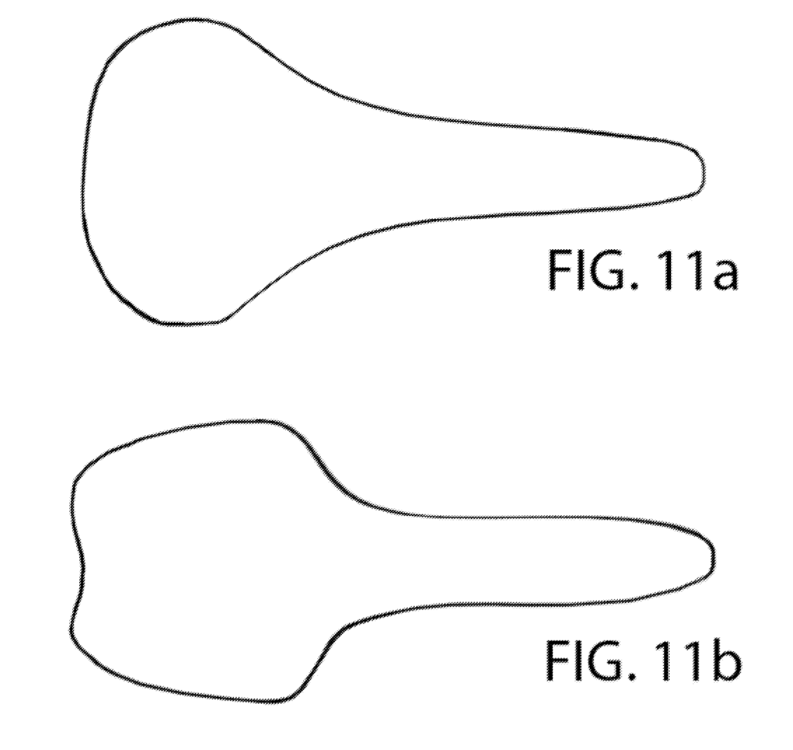

Referring to FIGS. 11A and 11B, a pair of top profiles illustrating some examples of adjustments that can be made to the web/wing portion 60 is shown. These adjustments again help with the pedal stroke of a rider and how far back the legs may extend without hitting into the seat.

In at least one embodiment the seat cover formed of textile material has a nose portion that is formed in a conical-like shape to slide over the nose portion of the frame. This textile material may be formed of several materials including trampoline material that is often tightly woven polyethylene or nylon, which allows for breathability, is UV resistant, and is very durable. The seat may be formed of a single piece of material and sewn or bonded together at various portions, along with having various mechanisms such as zippers incorporated therein to be used with the frame described herein. The textile could be a trampoline fabric such as a basket-weaving of polypropylene plastic with a filler (carbon black) for additional weatherproofing.

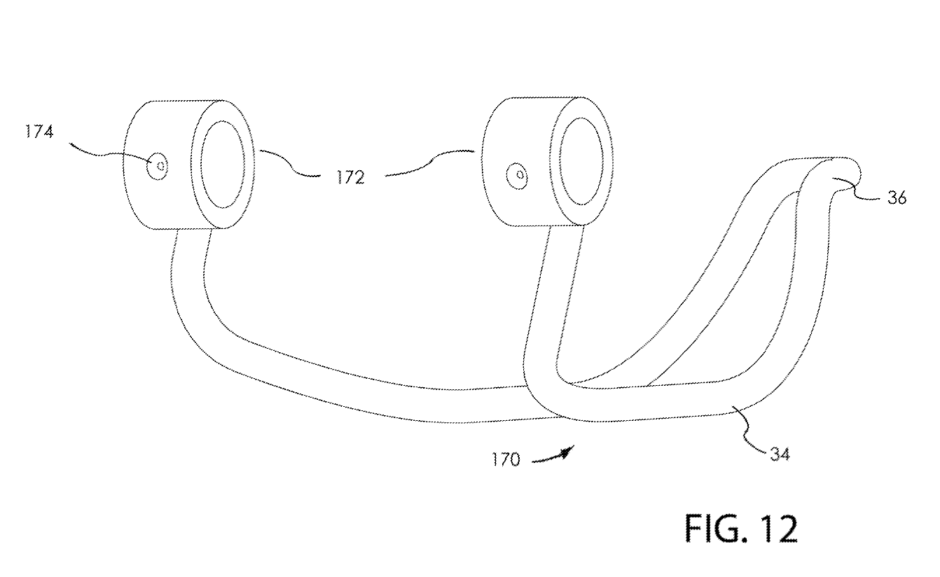

Referring to FIG. 12, a frame 170 having a pair of coupling mechanisms 172 is shown. The frame 170 of the seat frame 168 has a pair of rails 34 that extend from the nose portion 36 to the coupling mechanisms 172. The coupling mechanisms 172 each have an opening 174 for a fastener.

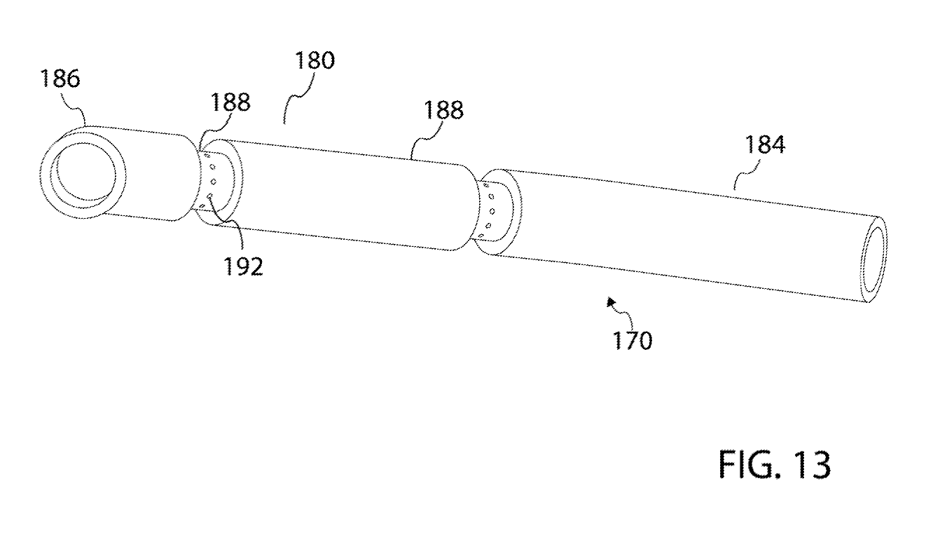

A crossbar 180, such as the one illustrated in FIG. 13 may be attached to the pair of coupling mechanisms 172 and even rotated about. Referring to FIG. 13, a crossbar 180 having a center back portion 182 and a left arm 184 and a right arm 186, is shown. The crossbar 180 of the seat frame 168, in addition to the center back portion 182 and the arms 184 and 186, has a pair of attachment points 188. The attachment points 188 may have a reduced diameter that fits inside of a coupling mechanism 172 of the frame 170. The attachment points 188 have a plurality of positioning taps 192 formed around the outer surface of the attachment point 188 which allow for a screw, bolt, pin, or fastening mechanism to pass through the opening 174 of the coupling mechanism 172 into the attachment mechanism 188.

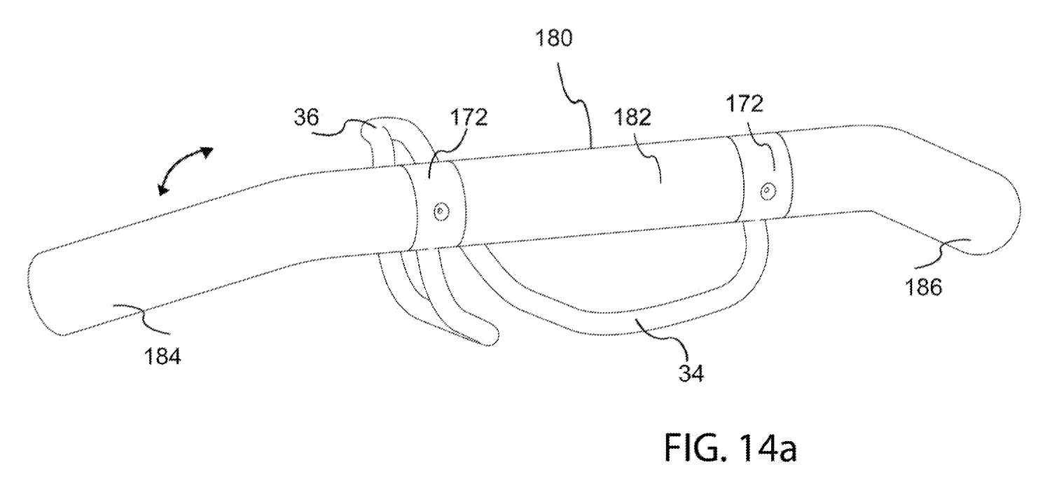

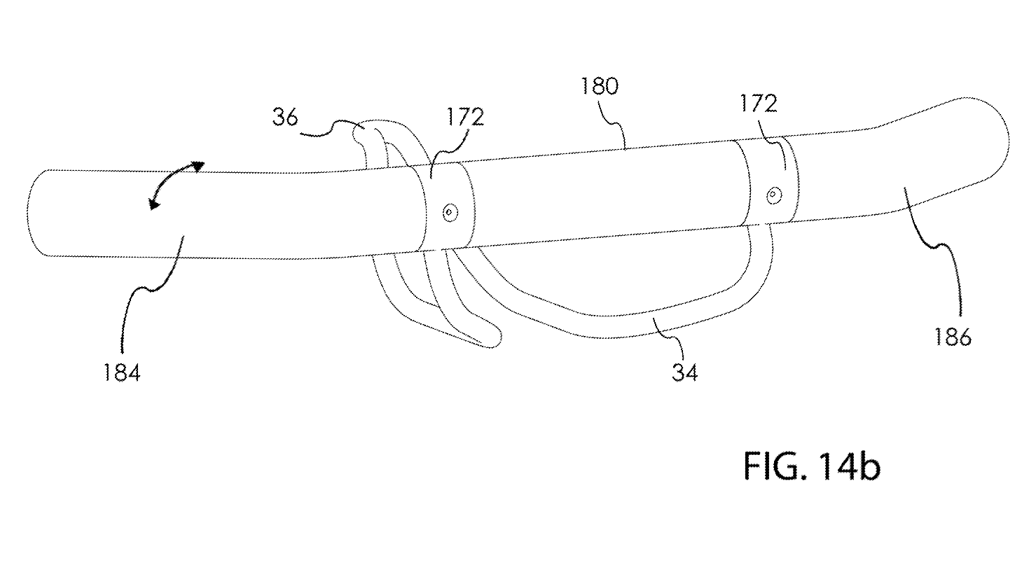

Referring to FIGS. 14A and 14B, the cross-bar and frame of FIGS. 12 and 13 are shown in two different configurations. In FIG. 14A, in the embodiment shown the crossbar 180 and arms 184 and 186 are pointed downward relative to the rails 34 of the seat frame 32. In FIG. 14B, the arms 184 and 186 are more level or planar with the nose portion 36 of the frame 32.

In some embodiments the crossbar 180 is a unibody shape, thus adjusting the tilt of the crossbar 180 up or down modifies the arms 184 and 186 pointing up or down. For example see FIGS. 11A-B. However, in other embodiments, the arms of the crossbar/endbar may be individually rotatable and adjusted accordingly. Opposite threaded screws may be used to affix the arms to the crossbar, such that when pressure is applied from a rider sitting on the seat, the arms on each side tighten. It is contemplated a hex wrench may be used to adjust hex screws affixing the arms to the crossbar/endbar.

Curvature can help the rider maintain position during more forward riding. The varying of the arms varies the flatness of the seat portion 50. If the arms are parallel to the ground, the surface across the seat segment of the seat portion is flat. However if the arms (wings) are rotated down 15 or 30 degrees into fixed slots, then the sitting surface across would be curved.

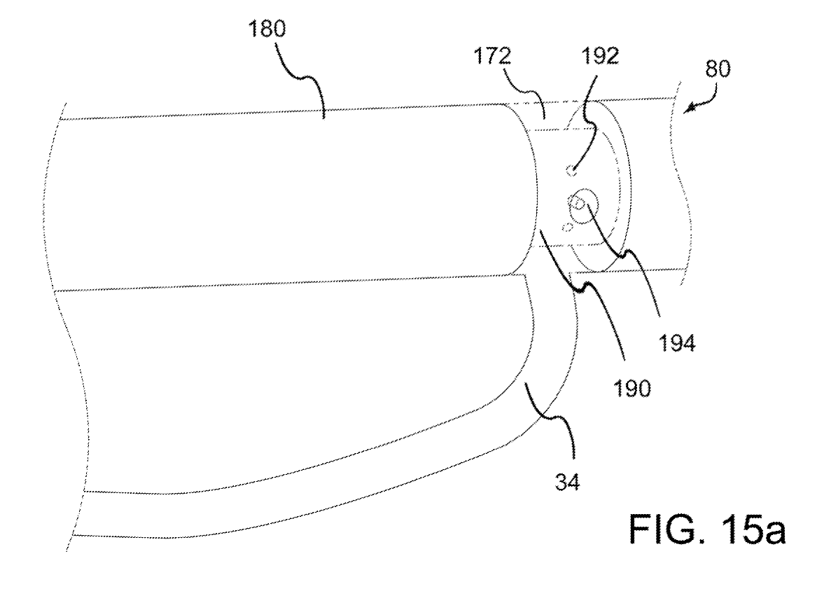

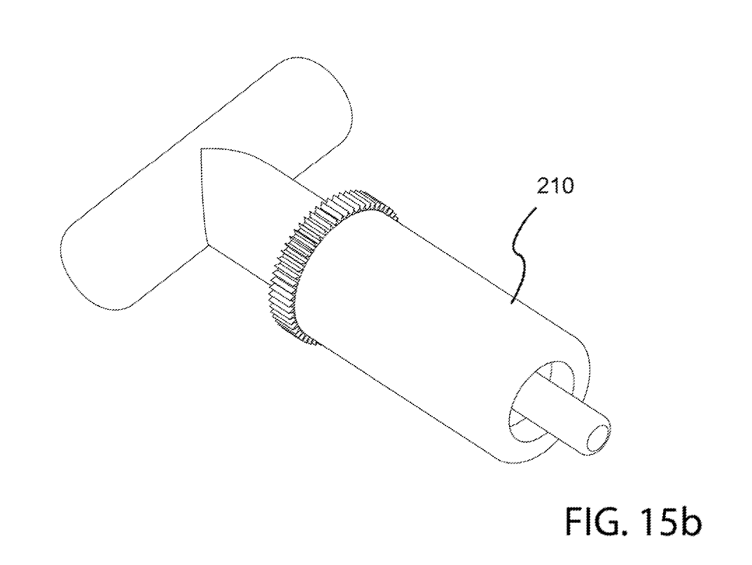

Referring to FIG. 15A a rotating mechanism for adjusting the crossbar 38 with respect to the attached seat frame 32 of the adjustable bicycle seat 80 is shown. Referring to FIG. 15B, a tool 210 to make such adjustment is shown. A closer view of attaching a crossbar 180 to the rail 34 of the seat frame 32 is shown. The attachment portion 188 is slid into the coupler 172 with a through-hole 194 that may used with the positioning taps/holes 192 to adjust the angle of the crossbar 180 relative to the frame as previously discussed. A detachable or permanently fixed tool 210, such as a T-handle pull pin, may be used to insert a pin that fixes the crossbar 180 in place relative to the frame, and through a pulling of the handle removes the pin to adjust the crossbar 180 around the circumferentially placed holes of the attachment portion 190. Again, this causes the arms, not seen here, to rotate up or down, which changes the surface area and pressure distribution lines of the seat cover formed over the frame. Other push/pull mechanisms may be similarly used that may or may not be spring loaded. For example, some exercise bikes have similar mechanisms to raise and lower the height of the seat.

The above description is merely illustrative. Having thus described several aspects of at least one embodiment of this invention including the preferred embodiments, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawing are by way of example only.

It is recognized that the seat portion 50 of the adjustable bicycle seat can be secured to the nose portion 36 of the seat frame 32 by various methods including by hook and loop fasteners; the nose segment 56 of the seat portion 50 is formed to receive the nose portion 36. The nose segment 56 can be formed by glue, staple, or sewn or other methods.

It is recognized the flexible material 52 of seat portion 50 can be formed of various outdoors-resistant materials. The material can consist of a single layer of rubber, textile, other materials or derivative of these materials. While multiple layers in certain embodiments will decrease ventilation and increase chafing discomfort, in certain embodiments multiple layers may use to increase stiffness and tailor the property of the seat portion 50.

It is recognized that the seat portion can have a high-friction coating or high friction material section on the seat segment of the seat portion. It is recognized that the nose segment can have a low-friction coating or a fabric. The distinction in coefficient of friction allows the rider to cycle their thighs past the nose portion with minimal friction-induced chafing.

It is recognized the tensioning segments including the adjustable mechanism can be other items beside the hook and loop fasteners and ratchet such pulley system, screws, bolts, zippers, cinches, magnets, and rivets.

What is claimed is:

1. A bicycle seat comprising:
a seat frame having a rail extending from a nose portion to a rear crossbar;
a seat portion of a flexible material that is formed over a portion of the nose and the crossbar,
an adjustable mounting mechanism interposed between the flexible material and the rear crossbar of the frame, wherein the adjustable mounting mechanism is capable of causing adjustment of at least a portion of the flexible material to transform along at least one direction and adjustment of the seating properties of the seat portion.

2. A bicycle seat of claim 1 wherein the adjustable mounting mechanism is a hook and loop fastener.

3. A bicycle seat of claim 1 wherein the adjustable mounting mechanism is a ratchet mechanism.

4. A bicycle seat of claim 1 further comprising a seat attachment and tilting mechanism is secured to rails.

5. A bicycle seat of claim 1 wherein the seat portion has a nose segment and a seat segment.

6. A bicycle seat of claim 5 wherein the flexible material of the seat portion is a woven material.

7. A bicycle seat of claim 5 wherein the flexible material of the seat portion is rubber.

8. A bicycle seat of claim 5 further comprising a low-friction or material coating on the nose segment of the flexible material.

9. A bicycle seat of claim 8 wherein the coating is Teflon.

10. A bicycle seat of claim 5 further comprising a high-friction material or coating on the seat portion.

11. A bicycle seat of claim 4 further comprising a plurality of openings in the material for venting.

12. A bicycle seat of claim 1 wherein the tensioning of the material along different dimensions causes the flexible material properties to adjust, such as the flatness and flexibility, respective to each dimension of tightening.

13. A bicycle seat of claim 1 wherein the ratio of the length of the seat portion to the width of the seat portion is greater than 1:1.2.

14. A bicycle seat of claim 13 wherein the ratio of the length of the seat portion to the width of the seat portion is greater than 1:1.5.

15. A bicycle seat of claim 1 wherein the ratio of the length of the seat portion to the height of the seat portion over the rails is a ratio of less than 7:1.

16. A bicycle seat comprising:
a frame comprising:
a frame having a nose and a rear section,
a rear crossbar rotatably connected to the rear section of the frame, and
a first tensioning mechanism; and
a textile material that is formed over a portion of the nose and crossbar,
wherein the tensioning mechanism may cause a portion of the textile material to morph along at least one direction, and
wherein the textile material is suspended from the nose to the rear crossbar.

17. A bicycle seat of claim 16, further including a stress distribution mechanism, configured to modify the tension lines formed in the textile material.

18. A bicycle seat of claim 17, wherein the stress distribution mechanism is a zipper formed around the textile material that forms around the nose portion of the seat.

19. A bicycle seat of claim 13, further including a contour-shaping mechanism, configured to adjust the contour of the arm portion of the textile material.

20. (canceled)

21. (canceled)

22. (canceled)

23. (canceled)

24. (canceled)

25. (canceled)

26. A bicycle seat comprising:
a seat frame having a rail that extends from a nose portion to a rear crossbar;
a seat portion of a flexible material that is formed over a portion of the nose and the crossbar, the seat portion having a nose segment and a seat segment; and
a hook and loop fastener interposed between the flexible material and the rear crossbar of the frame, wherein the adjustable mounting mechanism is capable of causing at least a portion of the flexible material to transform along at least one direction, and wherein the flexible material is suspended from the nose to the rear crossbar, wherein the transformation of the material causes the material to change the position of the seat portion.

27. (canceled)

28. (canceled)

29. (canceled)

30. (canceled)

31. (canceled)
